(19) United States
(12) Patent Application Publication
(10) Pub. No.: US 2024/0407594 A1
(43) Pub. Date: Dec. 12, 2024

(54) BABY BOTTLE SHAKER WITH WARMING FUNCTION

(71) Applicant: Ying Hong, Wuxi (CN)

(72) Inventor: Ying Hong, Wuxi (CN)

(21) Appl. No.: 18/813,783

(22) Filed: Aug. 23, 2024

(30) Foreign Application Priority Data
Jul. 17, 2024 (CN) 202410959277.0

(51) Int. Cl. A47J 36/24; A47J 36/32; B01F 31/60; B01F 101/06

(52) U.S. Cl. CPC A47J 36/2411; A47J 36/32; B01F 31/60; B01F 2101/06

(57) ABSTRACT

The present disclosure relates to a baby bottle shaker with a warming function, which solves the technical problems of the poor shaking effect of the existing baby bottle shaker. The baby bottle shaker includes a housing; a heating cylinder body with a placement chamber configured to place a container is movably arranged in the housing. The baby bottle shaker has the advantages that: Through the air bag type heating sheet pressing mechanism, the heating sheets can resist against an outer wall of the container to ensure the heating effect; and it is convenient for a user to control the air bag type heating sheet pressing mechanism through an expansion and contraction control assembly. An eccentric type container shaking assembly is provided with three eccentric rotating shafts, which can effectively ensure the shaking effect on the container on the base.

### TECHNICAL FIELD

The present disclosure belongs to the technical field of baby bottle shaker equipment, and in particular, to a baby bottle shaker with a warming function.

### BACKGROUND

As a mommy and baby product, a baby bottle shaker is mainly configured to help parents to automatically shake a baby bottle to fully dissolve milk powder when the parents brew the milk powder, thereby avoiding the problems such as non-uniformity, bubbles, and caking that may be caused by manual shaking. Moreover, the existing baby bottle shaker is provided with a heating structure to ensure the dissolution effect of the milk powder. However, most of the existing heating structures are arranged at a bottom of the baby bottle shaker. As a result, the heating structure cannot uniformly heat the baby bottle. Furthermore, there is no heat conduction structure, so that the heating effect is poor. Moreover, most driving mechanisms for the existing baby bottle shaker drive the baby bottle to shake through a single rotating shaft of a single motor, which causes a poor shaking effect. This affects the dissolution effect of the milk powder and affects the user experience.

To address the shortcomings in the prior art, people have conducted long-term exploration and proposed various solutions. For example, a Chinese patent literature discloses a side-heating baby bottle shaker [202123172164.7], including a base, a machine body fixed on the base, and a driving mechanism arranged in the base; a baby bottle shaking cylinder connected to the driving mechanism is arranged in the machine body; a heating cylinder seat with an opening in a top surface is further arranged in the machine body; a diathermanous slot is provided on a side wall of the heating cylinder seat; a shaft hole is provided in the middle of a bottom wall of the heating cylinder seat; a main shaft of the driving structure is fixed with the baby bottle shaking cylinder through the shaft hole; a heating structure is fixed on an outer wall of the heating cylinder seat; a heat dissipation slot is provided on a side wall of the baby bottle shaking cylinder; and a top of an inner chamber of the baby bottle shaking cylinder is clamped with a baby bottle positioning structure.

The above solution solves the problem of non-uniform heating of the existing baby bottle shaker to an extent. However, this solution still has many shortcomings. For example, the driving structure of the baby bottle shaker still drives a rotating shaft using a single motor to drive the baby bottle shaker to shake, so that the shaking effect of the existing baby bottle shaker is poor, and the dissolution effect of the milk powder is affected.

### SUMMARY

The present disclosure aims to provide a baby bottle shaker with a warming function.

To achieve the above objectives, the present disclosure uses the following technical solutions: A baby bottle shaker includes a housing; a heating cylinder body with a placement chamber configured to place a container is movably arranged in the housing; an upper end of the heating cylinder body is provided with an opening, and an insertion port for inserting the container into the placement chamber is formed at an upper end of the housing; several heating sheets located at a circumferential periphery of the container are arranged in the heating cylinder body; an air bag type heating sheet pressing mechanism that enables the various heating sheets to move towards an outer side of the container to be in contact with the outer side of the container is arranged on an inner circumferential direction of the heating cylinder body; and an eccentric type container shaking mechanism connected to a bottom of the heating cylinder body is arranged in the housing. The eccentric type container shaking mechanism can rotatably shake the container to enhance the dissolution effect on an object in the container.

In the above baby bottle shaker with the warming function, the air bag type heating sheet pressing mechanism includes an expansion and contraction air bag that is arranged on an inner circumferential side of the heating cylinder body and is made of an elastic material; the heating sheets are distributed on an inner circumferential side of the expansion and contraction air bag; the expansion and contraction air bag is internally provided with an annular air bag chamber; and an expansion and contraction control assembly connected to the air bag chamber is arranged in the housing. The expansion and contraction control assembly can adjust the size of the air bag chamber, thereby adjusting the size of the expansion and contraction air bag. Furthermore, the heating sheets are arranged on the inner circumferential side of the expansion and contraction air bag, and the heating sheets resist against the container by adjusting the size of the expansion and contraction air bag, so that the heating efficiency is improved.

In the above baby bottle shaker with the warming function, the expansion and contraction air bag is cylindrical; an upper end of the expansion and contraction air bag extends to an inner circumferential side of an upper end of the heating cylinder body, and a lower end of the expansion and contraction air bag extends to an inner circumferential side of a lower end of the heating cylinder body; the heating sheets are uniformly arranged on the inner circumferential side of the expansion and contraction air bag; and a thermal insulation layer is arranged between the heating sheets and the expansion and contraction air bag; or, the expansion and contraction air bag is made of a high-temperature-resistant elastic material. Through the high-temperature-resistant elastic material, the cost of a thermal insulation layer can be saved; and it ensures that the expansion and contraction air bag can bear the heating temperature of the heating sheets, to ensure the service life of the expansion and contraction air bag.

In the baby bottle shaker with the warming function, protective cloth located on sides of the heating sheets away from the expansion and contraction air bag is arranged on the inner circumferential side of the heating cylinder body; lengths of two ends of the protective cloth are greater than a length of the heating cylinder body, and two sides of the protective cloth are connected and enclosed into a barrel-shaped protective body; an upper end of the protective body is connected to the upper end of the heating cylinder body; and a lower end of the protective body is connected to the lower end of the heating cylinder body. Furthermore, the protective body resists against the container to enhance the protective effect on the heating sheets and ensure the heating effect of the heating sheets.

In the baby bottle shaker with the warming function, the expansion and contraction control assembly includes a pump valve arranged in the housing; the pump valve is communicated to the air bag chamber of the expansion and contraction air bag through an air delivery pipe; the pump valve is connected to a circuit board arranged in the housing; the heating sheets are connected to the circuit board through a wire; and a pipeline hole for allowing the air delivery pipe and the wire to pass through is provided on the heating cylinder body. Through the pipeline hole, it is convenient for a user to control a heating state of the heating sheets and the size of the expansion and contraction air bag through the circuit board; the user operation is facilitated; and the user experience is enhanced.

In the baby bottle shaker with the warming function, the heating cylinder body is cylindrical, and the upper and lower ends of the heating cylinder body are respectively provided with openings; the upper end of the heating cylinder body is sleeved with an annular portion; the lower end of the heating cylinder body is sleeved with a base capable of closing the opening at the lower end; and both the annular portion and the base are clamped to the heating cylinder body and are circumferentially positioned. Through the clamped connection, the connection stability between the annular portion, as well as the base, and the heating cylinder body can be ensured; the normal operation of the equipment can be ensured; and the service life is prolonged.

In the baby bottle shaker with the warming function, the eccentric type container shaking mechanism includes an annular platform arranged on an inner side of a lower end of the housing; and the annular platform is connected to the base through an eccentric type container shaking assembly. Furthermore, the eccentric type container shaking assembly can drive the base to shake, thereby driving the container to shake; and it can ensure the shaking effect of the eccentric type container shaking assembly.

In the baby bottle shaker with the warming function, the eccentric type container shaking assembly includes several platform mounting holes circumferentially and uniformly arranged on the annular platform; the base is provided with several base mounting holes which are one-to-one correspondence to the platform mounting holes; eccentric rotating shafts are respectively arranged between the platform mounting holes and the base mounting holes; upper ends of the eccentric rotating shafts are rotatably mounted in the base mounting holes through base bearings; lower ends of the eccentric rotating shafts are rotatably mounted in the platform mounting holes through platform bearings; and one eccentric rotating shaft of the several eccentric rotating shafts are connected to an output shaft of a driving motor. The output shaft can drive the eccentric rotating shafts to rotate; and when one eccentric rotating shaft rotates, the other two eccentric rotating shafts can rotate together, which enhances the shaking effect on the container on the base.

In the baby bottle shaker with the warming function, a central hole is provided in a center of the annular platform; a mounting tube portion arranged in the central hole in a penetrating manner is arranged in a center of a lower end of the base; a temperature measuring assembly extending into the heating cylinder body and in contact with a bottom of the container is arranged in the mounting tube portion; and a lower end of the temperature measuring assembly is threaded out of the mounting tube portion and is connected to the circuit board. The temperature measuring assembly can measure the temperature of the container. The lower end of the temperature measuring assembly is threaded out of the mounting tube portion and is connected to the circuit board; and through the circuit board, it is convenient for a user to observe and control the temperature in the container, thereby ensuring the heating effect.

In the baby bottle shaker with the warming function, the housing includes a main housing; a mounting gap is provided on one side of the main housing; the heating cylinder body and the annular platform are both located in the mounting gap; a protective cylinder body clamped to the annular platform and located on an outer circumferential side of the heating cylinder body is arranged in the mounting gap; an outer housing capable of closing the mounting gap and covering outer sides of the protective cylinder body, the heating cylinder body, and the annular platform is arranged on one side of the main housing; and a control switch connected to the circuit board is arranged at an upper end of one side of the main housing away from the mounting gap.

Compared with the prior art, the present disclosure has the advantages below:

1. Through the air bag type heating sheet pressing mechanism, the heating sheets can resist against the outer wall of the container to ensure the heating effect. The protective cloth is arranged between the heating sheets and the container, which can achieve a protective effect.

2. Through the expansion and contraction control assembly, it is convenient for a user to control the air bag type heating sheet pressing mechanism, the user operation is facilitated, which further enhances the heating effect.

3. The eccentric type container shaking mechanism is provided with the three eccentric rotating shafts, which can effectively ensure the shaking effect on the container on the base.

4. The thermal insulation layer between the expansion and contraction air bag and the heating sheets can achieve a protective effect on the expansion and contraction air bag and prolong the service life of the expansion and contraction air bag, or the expansion and contraction air bag is made of the high-temperature-resistant elastic material, which can reduce the production cost and prolong the service life of the expansion and contraction air bag.

### BRIEF DESCRIPTION OF THE DRAWINGS

FIG. 1 is a schematic structural diagram of the present disclosure.

FIG. 2 is a structural cross-sectional view of the present disclosure.

FIG. 3 is a structural cross-sectional view of a heating cylinder body in the present disclosure.

FIG. 4 is a schematic structural diagram of an eccentric type container shaking mechanism in the present disclosure.

FIG. 5 is a schematic structural diagram of an eccentric type container shaking assembly in the present disclosure.

FIG. 6 is a schematic structural diagram of an expansion and contraction control assembly in the present disclosure.

In the drawings: 1: housing: 11: insertion port; 12: main housing; 121: mounting gap; 122: control switch; 13: protective cylinder body; 14: outer housing; 2: container; 3: heating cylinder body; 31: placement chamber; 32: heating sheet; 33: protective cloth; 34: protective body; 35: annular portion; 36: base; 361: mounting tube portion; 4: air bag type heating sheet pressing mechanism; 41: expansion and contraction air bag; 42: air bag chamber; 5: eccentric type container shaking mechanism; 51: annular platform; 511: central hole; 52: eccentric type container shaking assembly; 521: platform mounting hole; 522: base mounting hole; 523: eccentric rotating shaft; 524: base bearing; 525: platform bearing; 526: driving motor; 527: output shaft; 6: expansion and contraction control assembly; 61: pump valve; 62: air delivery pipe; 63: circuit board; 64: pipeline hole; 7: thermal insulation layer; 8: temperature measuring assembly; 81: temperature measuring mounting seat; and 82: temperature measuring probe.

### DETAILED DESCRIPTION OF THE EMBODIMENTS

The present disclosure will be further explained in detail below in conjunction with the accompanying drawings and specific implementations.

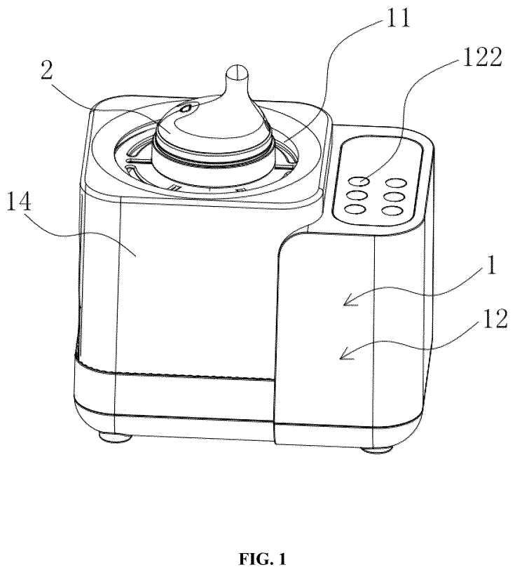

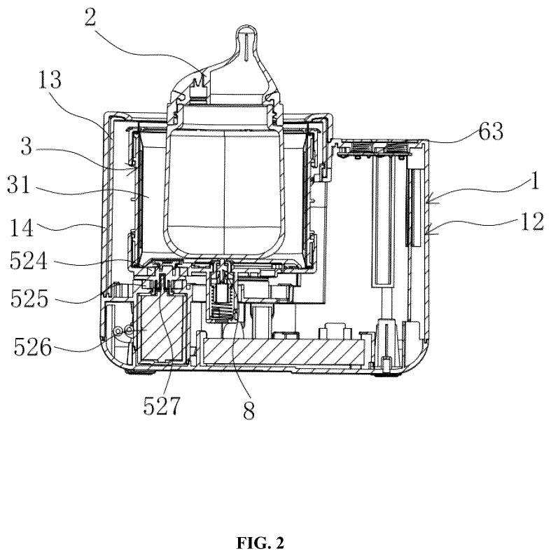

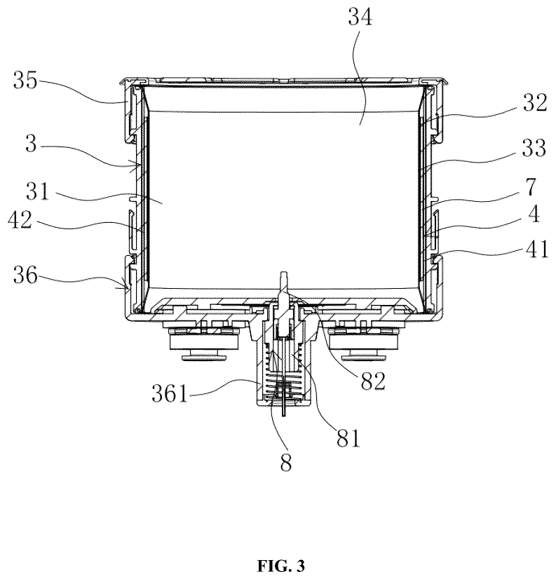

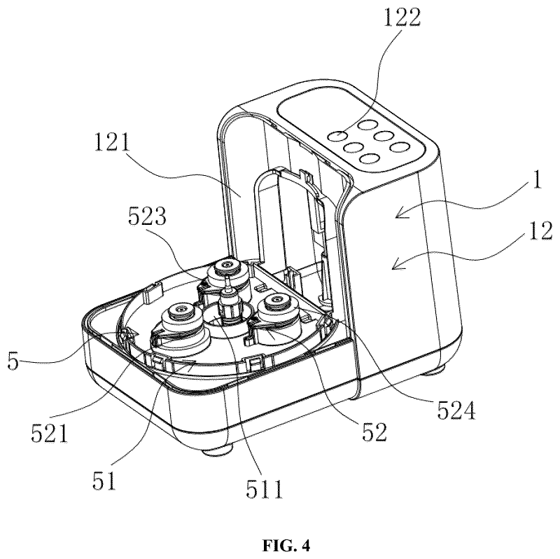

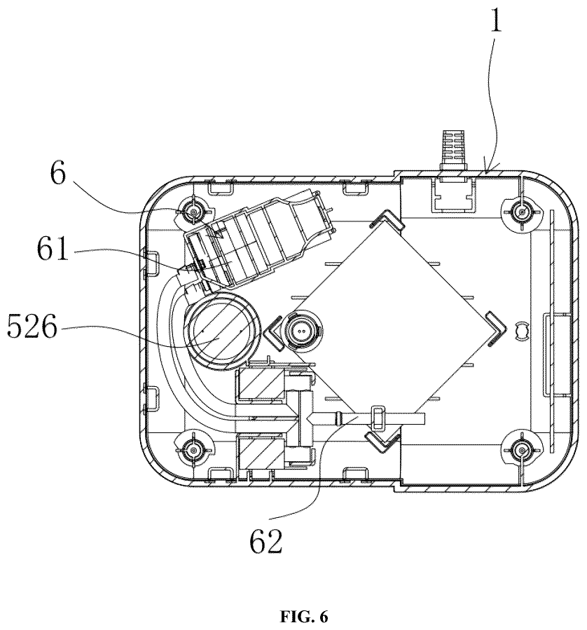

As shown in FIG. 1, FIG. 2, FIG. 3, FIG. 4, and FIG. 6, a baby bottle shaker with a warming function includes a housing 1. A heating cylinder body 3 with a placement chamber 31 configured to place a container 2 is movably arranged in the housing 1. An upper end of the heating cylinder body 3 is provided with an opening, and an insertion port 11 for inserting the container 2 into the placement chamber 31 is formed at an upper end of the housing 1. Through the insertion port 11, the placement efficiency of the container 2 can be improved. Several heating sheets 32 located at a circumferential periphery of the container 2 are arranged in the heating cylinder body 3. Through the heating sheets 32 arranged at the circumferential periphery, the heating effect on the container 2 can be enhanced. An air bag type heating sheet pressing mechanism 4 that enables the various heating sheets 32 to move towards an outer side of the container 2 to be in contact with the outer side of the container 2 is arranged on an inner circumferential direction of the heating cylinder body 3. Through the air bag type heating sheet pressing mechanism 4, the heating effect achieved by the heating sheets 32 on the container 2 can be enhanced, and a distance between the heating sheets 32 and the container 2 can be adjusted according to an outer diameter of the container 2, which further enhances the heating effect. An eccentric type container shaking mechanism 5 connected to a bottom of the heating cylinder body 3 is arranged in the housing 1. The eccentric type container shaking mechanism 5 can rotatably shake the container 2 to enhance the dissolution effect on an object in the container 2.

Specifically, the air bag type heating sheet pressing mechanism 4 includes an expansion and contraction air bag 41 that is arranged on an inner circumferential side of the heating cylinder body 3 and is made of an elastic material; the heating sheets 32 are distributed on an inner circumferential side of the expansion and contraction air bag 41; the expansion and contraction air bag 41 is internally provided with an annular air bag chamber 42; and an expansion and contraction control assembly 6 connected to the air bag chamber 42 is arranged in the housing 1. The expansion and contraction control assembly 6 can adjust the size of the air bag chamber 42, thereby adjusting the size of the expansion and contraction air bag 42. Furthermore, the heating sheets 32 are arranged on the inner circumferential side of the expansion and contraction air bag 41, and the heating sheets 32 resist against the container 2 by adjusting the size of the expansion and contraction air bag 42, so that the heating efficiency is improved.

The expansion and contraction air bag 41 is cylindrical; an upper end of the expansion and contraction air bag 41 extends to an inner circumferential side of an upper end of the heating cylinder body 3, and a lower end of the expansion and contraction air bag 41 extends to an inner circumferential side of a lower end of the heating cylinder body 3, so that an expansion and contraction area of the expansion and contraction air bag 41 in the heating cylinder body 3 can be ensured, which ensures that the expansion and contraction air bag 41 can abut against the container 2. The heating sheets 32 are uniformly arranged on the inner circumferential side of the expansion and contraction air bag 41, to ensure the heating effect achieved by the heating sheets 32 on the container 2. A thermal insulation layer 7 is arranged between the heating sheets 32 and the expansion and contraction air bag 41. The thermal insulation layer 7 is formed by a layer of silica gel sheet and a layer of aluminum foil sheet. Furthermore, the thermal insulation layer 7 can protect the expansion and contraction air bag 41 to prevent the expansion and contraction air bag 41 from being damaged by the heating of the heating sheets 32, so that the service life of the expansion and contraction air bag 41 is prolonged. Or, the expansion and contraction air bag 41 is made of a high-temperature-resistant elastic material. Through the high-temperature-resistant elastic material, the cost of a thermal insulation layer 7 can be saved; and it ensures that the expansion and contraction air bag 41 can bear the heating temperature of the heating sheets 32, to ensure the service life of the expansion and contraction air bag 41.

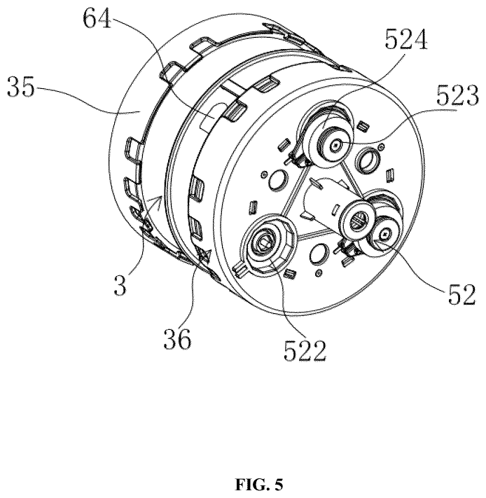

As shown in FIG. 2, FIG. 3, FIG. 5, and FIG. 6, protective cloth 33 located on sides of the heating sheets 32 away from the expansion and contraction air bag 41 is arranged on the inner circumferential side of the heating cylinder body 3. The protective cloth 33 can achieve a protective effect on the heating sheets 32. Lengths of two ends of the protective cloth 33 are greater than a length of the heating cylinder body 3, and two sides of the protective cloth 33 are connected and enclosed into a barrel-shaped protective body 34; an upper end of the protective body 34 is connected to the upper end of the heating cylinder body 3; and a lower end of the protective body 34 is connected to the lower end of the heating cylinder body 3. Furthermore, the protective body 34 resists against the container 2 to enhance the protective effect on the heating sheets 32 and ensure the heating effect of the heating sheets 32.

Further, the expansion and contraction control assembly 6 includes a pump valve 61 arranged in the housing 1; the pump valve 61 is communicated to the air bag chamber 42 of the expansion and contraction air bag 41 through an air delivery pipe 62; and the pump valve 61 can control the size of the expansion and contraction air bag 41 through the air delivery pipe 62. The pump valve 61 is connected to a circuit board 63 arranged in the housing 1. Through the circuit board 63, it is convenient for a user to control the pump valve 61, thereby facilitating the control of the size of the expansion and contraction air bag 41. The heating sheets 32 are connected to the circuit board 63 through a wire; and a pipeline hole 64 for allowing the air delivery pipe 62 and the wire to pass through is provided on the heating cylinder body 3. Through the pipeline hole 64, it is convenient for a user to control a heating state of the heating sheets 32 and the size of the expansion and contraction air bag 41 through the circuit board 63; the user operation is facilitated; and the user experience is enhanced.

The heating cylinder body 3 is cylindrical, and the upper and lower ends of the heating cylinder body 3 are respectively provided with openings; the upper end of the heating cylinder body 3 is sleeved with an annular portion 35; and the lower end of the heating cylinder body 3 is sleeved with a base 36 capable of closing the opening at the lower end. A lower end of the container 2 resists against the base 36, which can improve the placement stability of the container 2 in the placement chamber 31. Both the annular portion 35 and the base 36 are clamped to the heating cylinder body 3 and are circumferentially positioned. Through the clamped connection, the connection stability between the annular portion 35, as well as the base 36, and the heating cylinder body 3 can be ensured; the normal operation of the equipment can be ensured; and the service life is prolonged.

As shown in FIG. 2, FIG. 3, FIG. 4, and FIG. 5, the eccentric type container shaking mechanism 5 includes an annular platform 51 arranged on an inner side of a lower end of the housing 1. The size of the annular platform 51 is greater than the size of the heating cylinder body 3. Through the annular platform 51, it is convenient to place the heating cylinder body 3, and the mounting efficiency is improved. The annular platform 51 is connected to the base 36 through an eccentric type container shaking assembly 52. Furthermore, the eccentric type container shaking assembly 52 can drive the base 36 to shake, thereby driving the container 2 to shake; and it can ensure the shaking effect of the eccentric type container shaking assembly 52.

The eccentric type container shaking assembly 52 includes several platform mounting holes 521 circumferentially and uniformly arranged on the annular platform 51; the base 36 is provided with several base mounting holes 522 which are one-to-one correspondence to the platform mounting holes 521; eccentric rotating shafts 523 are respectively arranged between the platform mounting holes 521 and the base mounting holes 522; and upper ends of the eccentric rotating shafts 523 are rotatably mounted in the base mounting holes 522 through base bearings 524. The base bearings 524 and the eccentric rotating shafts 523 can drive the base 36 to shake. Lower ends of the eccentric rotating shafts 523 are rotatably mounted in the platform mounting holes 521 through platform bearings 525; and one eccentric rotating shaft 523 of the several eccentric rotating shafts 523 are connected to an output shaft 527 of a driving motor 526. The output shaft 527 can drive the eccentric rotating shafts 523 to rotate; and when one eccentric rotating shaft 523 rotates, the other two eccentric rotating shafts 523 can rotate together, which enhances the shaking effect on the container 2 on the base 36.

Specifically, a central hole 511 is provided in a center of the annular platform 51; and a mounting tube portion 361 arranged in the central hole 511 in a penetrating manner is arranged in a center of a lower end of the base 36. A radius of the mounting tube portion 361 is less than a radius of the central hole 511, which can ensure that the mounting tube portion 361 can be shaken in the central hole 511 in the shaking process of the base 36. A temperature measuring assembly 8 extending into the heating cylinder body 3 and in contact with a bottom of the container 2 is arranged in the mounting tube portion 361. The temperature measuring assembly 8 is provided with a temperature measuring mounting seat 81 arranged in the mounting tube portion 361; one end of the temperature measuring mounting seat 81 is arranged in the mounting tube portion 361 in a resisting manner through a spring; and a temperature measuring probe 82 arranged in the placement chamber 31 in an extending manner is arranged at the other end of the temperature measuring mounting seat 81. One end of the temperature measuring probe 82 resists against the bottom of the container 2. Through the temperature measuring probe 82, the temperature of the container 2 can be measured. A lower end of the temperature measuring assembly 8 is threaded out of the mounting tube portion 361 and is connected to the circuit board 63. Furthermore, the temperature measuring probe 82 is connected to the circuit board 63 through a wire. The circuit board 63 can facilitate a user to observe and control the temperature in the container 2, thereby ensuring the heating effect.

As shown in FIG. 1, FIG. 2, FIG. 4, FIG. 5, and FIG. 6, the housing 1 includes a main housing 12; a mounting gap 121 is provided on one side of the main housing 12; the heating cylinder body 3 and the annular platform 51 are both located in the mounting gap 121; and a protective cylinder body 13 clamped to the annular platform 51 and located on an outer circumferential side of the heating cylinder body 3 is arranged in the mounting gap 121. Through the protective cylinder body 13 can achieve a protective effect on the heating cylinder 3, which prolongs the service life. An outer housing 14 capable of closing the mounting gap 121 and covering outer sides of the protective cylinder body 13, the heating cylinder body 3, and the annular platform 51 is arranged on one side of the main housing 12. The outer housing 14 can achieve a protective effect and can beautify the appearance. A control switch 122 connected to the circuit board 63 is arranged at an upper end of one side of the main housing 12 away from the mounting gap 121. Through the control switch 122, it is convenient for a user to control the heating sheets 32, the expansion and contraction control assembly 6, and the eccentric type container shaking assembly 52 through the circuit board 63, which ensures the heating effect and shaking effect on the container 2.

The principle of this embodiment is that: The container 2 is arranged in the placement chamber 31 through the insertion port 11, and the other end of the container 2 is arranged on the base 36. The expansion and contraction control assembly 6 is controlled to enable the protective cloth 33 on one side of the expansion and contraction air bag 41 to resist against a side wall of the container 2, and the heating sheets 32 are arranged on the expansion and contraction air bag 41 and heat the container 2 through the protective cloth 33; the eccentric type container shaking assembly 52 is provided with the three eccentric rotating shafts 523; when rotating, one eccentric rotating shaft 523 can drive the other two eccentric rotating shafts 523 to rotate, thereby enhancing the shaking effect; and the eccentric type container shaking assembly 52 can drive the base 36 to shake, thereby ensuring the shaking effect of the eccentric type container shaking assembly 52 on the container.

The specific embodiments described herein are only illustrative examples of the spirit of the present disclosure. A person skilled in the art to which the present disclosure belongs can make various modifications or supplements to the specific embodiments described or use similar manners to replace the specific embodiments, without deviating from the spirit of the present disclosure or going beyond the scope defined in the attached claims.

The following terms are more frequently used herein: 1: housing: 11: insertion port; 12: main housing; 121: mounting gap; 122: control switch; 13: protective cylinder body; 14: outer housing; 2: container; 3: heating cylinder body; 31: placement chamber; 32: heating sheet; 33: protective cloth; 34: protective body; 35: annular portion; 36: base; 361: mounting tube portion; 4: air bag type heating sheet pressing mechanism; 41: expansion and contraction air bag; 42: air bag chamber; 5: eccentric type container shaking mechanism; 51: annular platform; 511: central hole; 52: eccentric type container shaking assembly; 521: platform mounting hole; 522: base mounting hole; 523: eccentric rotating shaft; 524: base bearing; 525: platform bearing; 526: driving motor; 527: output shaft; 6: expansion and contraction control assembly; 61: pump valve; 62: air delivery pipe; 63: circuit board; 64: pipeline hole; 7: thermal insulation layer; 8: temperature measuring assembly; 81: temperature measuring mounting seat; and 82: temperature measuring probe, but other terms are not excluded. The use of these terms is only for the convenience of describing and explaining the essence of the present disclosure. Interpreting them as any additional limitation is contrary to the spirit of the present disclosure.

What is claimed is:

1. A baby bottle shaker with a warming function, comprising a housing (1), wherein a heating cylinder body (3) with a placement chamber (31) configured to place a container (2) is movably arranged in the housing (1); an upper end of the heating cylinder body (3) is provided with an opening, and an insertion port (11) for inserting the container (2) into the placement chamber (31) is formed at an upper end of the housing (1); several heating sheets (32) located at a circumferential periphery of the container (2) are arranged in the heating cylinder body (3); an air bag type heating sheet pressing mechanism (4) that enables the various heating sheets (32) to move towards an outer side of the container (2) to be in contact with the outer side of the container (2) is arranged on an inner circumferential direction of the heating cylinder body (3); and an eccentric type container shaking mechanism (5) connected to a bottom of the heating cylinder body (3) is arranged in the housing (1).

2. The baby bottle shaker with the warming function according to claim 1, wherein the air bag type heating sheet pressing mechanism (4) comprises an expansion and contraction air bag (41) that is arranged on an inner circumferential side of the heating cylinder body (3) and is made of an elastic material; the heating sheets (32) are distributed on an inner circumferential side of the expansion and contraction air bag (41); the expansion and contraction air bag (41) is internally provided with an annular air bag chamber (42); and an expansion and contraction control assembly (6) connected to the air bag chamber (42) is arranged in the housing (1).

3. The baby bottle shaker with the warming function according to claim 2, wherein the expansion and contraction air bag (41) is cylindrical; an upper end of the expansion and contraction air bag (41) extends to an inner circumferential side of an upper end of the heating cylinder body (3), and a lower end of the expansion and contraction air bag (41) extends to an inner circumferential side of a lower end of the heating cylinder body (3); the heating sheets (32) are uniformly arranged on the inner circumferential side of the expansion and contraction air bag (41); and a thermal insulation layer (7) is arranged between the heating sheets (32) and the expansion and contraction air bag (41); or, the expansion and contraction air bag (41) is made of a high-temperature-resistant elastic material.

4. The baby bottle shaker with the warming function according to claim 2, wherein protective cloth (33) located on sides of the heating sheets (32) away from the expansion and contraction air bag (41) is arranged on the inner circumferential side of the heating cylinder body (3); lengths of two ends of the protective cloth (33) are greater than a length of the heating cylinder body (3), and two sides of the protective cloth (33) are connected and enclosed into a barrel-shaped protective body (34); an upper end of the protective body (34) is connected to the upper end of the heating cylinder body (3); and a lower end of the protective body (34) is connected to the lower end of the heating cylinder body (3).

5. The baby bottle shaker with the warming function according to claim 2, wherein the expansion and contraction control assembly (6) comprises a pump valve (61) arranged in the housing (1); the pump valve (61) is communicated to the air bag chamber (42) of the expansion and contraction air bag (41) through an air delivery pipe (62); the pump valve (61) is connected to a circuit board (63) arranged in the housing (1); the heating sheets (32) are connected to the circuit board (63) through a wire; and a pipeline hole (64) for allowing the air delivery pipe (62) and the wire to pass through is provided on the heating cylinder body (3).

6. The baby bottle shaker with the warming function according to claim 3, wherein the expansion and contraction control assembly (6) comprises a pump valve (61) arranged in the housing (1); the pump valve (61) is communicated to the air bag chamber (42) of the expansion and contraction air bag (41) through an air delivery pipe (62); the pump valve (61) is connected to a circuit board (63) arranged in the housing (1); the heating sheets (32) are connected to the circuit board (63) through a wire; and a pipeline hole (64) for allowing the air delivery pipe (62) and the wire to pass through is provided on the heating cylinder body (3).

7. The baby bottle shaker with the warming function according to claim 4, wherein the expansion and contraction control assembly (6) comprises a pump valve (61) arranged in the housing (1); the pump valve (61) is communicated to the air bag chamber (42) of the expansion and contraction air bag (41) through an air delivery pipe (62); the pump valve (61) is connected to a circuit board (63) arranged in the housing (1); the heating sheets (32) are connected to the circuit board (63) through a wire; and a pipeline hole (64) for allowing the air delivery pipe (62) and the wire to pass through is provided on the heating cylinder body (3).

8. The baby bottle shaker with the warming function according to claim 5, wherein the heating cylinder body (3) is cylindrical, and the upper and lower ends of the heating cylinder body (3) are respectively provided with openings; the upper end of the heating cylinder body (3) is sleeved with an annular portion (35); the lower end of the heating cylinder body (3) is sleeved with a base (36) capable of closing the opening at the lower end; and both the annular portion (35) and the base (36) are clamped to the heating cylinder body (3) and are circumferentially positioned.

9. The baby bottle shaker with the warming function according to claim 8, wherein the eccentric type container shaking mechanism (5) comprises an annular platform (51) arranged on an inner side of a lower end of the housing (1); and the annular platform (51) is connected to the base (36) through an eccentric type container shaking assembly (52).

10. The baby bottle shaker with the warming function according to claim 9, wherein the eccentric type container shaking assembly (52) comprises several platform mounting holes (521) circumferentially and uniformly arranged on the annular platform (51); the base (36) is provided with several base mounting holes (522) which are one-to-one correspondence to the platform mounting holes (521); eccentric rotating shafts (523) are respectively arranged between the platform mounting holes (521) and the base mounting holes (522); upper ends of the eccentric rotating shafts (523) are rotatably mounted in the base mounting holes (522) through base bearings (524); lower ends of the eccentric rotating shafts (523) are rotatably mounted in the platform mounting holes (521) through platform bearings (525); and one eccentric rotating shaft (523) of the several eccentric rotating shafts (523) are connected to an output shaft (527) of a driving motor (526).

11. The baby bottle shaker with the warming function according to claim 9, wherein a central hole (511) is provided in a center of the annular platform (51); a mounting tube portion (361) arranged in the central hole (511) in a penetrating manner is arranged in a center of a lower end of the base (36); a temperature measuring assembly (8) extending into the heating cylinder body (3) and in contact with a bottom of the container (2) is arranged in the mounting tube portion (361); and a lower end of the temperature measuring assembly (8) is threaded out of the mounting tube portion (361) and is connected to the circuit board (63).

12. The baby bottle shaker with the warming function according to claim 9, wherein the housing (1) comprises a main housing (12); a mounting gap (121) is provided on one side of the main housing (12); the heating cylinder body (3) and the annular platform (51) are both located in the mounting gap (121); a protective cylinder body (13) clamped to the annular platform (51) and located on an outer circumferential side of the heating cylinder body (3) is arranged in the mounting gap (121); an outer housing (14) capable of closing the mounting gap (121) and covering outer sides of the protective cylinder body (13), the heating cylinder body (3), and the annular platform (51) is arranged on one side of the main housing (12); and a control switch (122) connected to the circuit board (63) is arranged at an upper end of one side of the main housing (12) away from the mounting gap (121).
